(19) United States
(12) Patent Application Publication
(10) Pub. No.: US 2008/0319849 A1
(43) Pub. Date: Dec. 25, 2008

(54) Apparatus and method for discount integration into an on-line pricing engine

(75) Inventor: Neal D. Rapoport, Plano, TX (US)

Correspondence Address: DOCKET CLERK, P.O. DRAWER 800889, DALLAS, TX, 75380, US

(73) Assignee: NARAE ENTERPRISES, INC., Plano, TX (US)

(21) Appl. No.: 11/820,281

(22) Filed: Jun. 19, 2007

(51) Int. Cl. G06Q 30/00

(52) U.S. Cl. 705/14

(57) ABSTRACT

A user may submit a request for pricing information for an item (such as a product or service). Multiple vendors that offer the item are identified, and multiple discounts associated with the item and/or the vendors are identified. A web page that includes pricing information associated with the item is provided to a user. For example, for each vendor, the web page could identify a price of the item offered by the vendor, a discount amount associated with one of the discounts, and a total cost of the item offered by the vendor (which is based on the discount amount). The web page presented to the user could initially identify an optimal discount for each of the vendors and present a link for each vendor. If the user selects a link, a pop-up window identifying multiple discounts honored by the vendor could be displayed for selection by the user.

### TECHNICAL FIELD

This disclosure is generally directed to on-line pricing systems and more specifically to an apparatus and method for discount integration into an on-line pricing engine.

### BACKGROUND

Many different businesses and other entities operate or support websites, such as websites that present product or service-related information to customers and that accept orders for products or services from customers. Price-tracking systems, often called “pricing engines,” typically allow users to search for products or services offered by multiple businesses or other entities. For example, a pricing engine website may allow a user to enter search criteria identifying a particular product. The pricing engine then typically searches for and returns a list of on-line vendors and other entities that offer the particular product. The pricing engine could also identify additional information, such as the shipping costs or taxes charged by the on-line vendors.

Many businesses (either on their own or through affiliated parties) also often provide coupons or other discounts for the products and services they provide. Tracking websites routinely track or compile lists of the discounts available for use with various on-line businesses or other entities. Users can access a tracking website and search for discounts related to a particular product or service, a particular vendor, or a particular product manufacturer or service provider. Often times, a user is required to copy a particular coupon code, visit an on-line vendor's website, and enter the coupon code in the appropriate location at the vendor's website.

### SUMMARY

This disclosure provides an apparatus and method for discount integration into an on-line pricing engine.

In a first embodiment, a method includes identifying multiple vendors that offer an item. The method also includes identifying multiple discounts associated with the item and/or the vendors. In addition, the method includes providing a web page that includes pricing information associated with the item to a user. At least some of the pricing information is based on at least one of the discounts.

In particular embodiments, multiple discounts are associated with each of one or more of the vendors. Also, the method further includes identifying an optimal discount for at least one of the vendors. At least some of the pricing information is based on the optimal discount.

In other particular embodiments, multiple discounts are associated with each of one or more of the vendors. Also, the method further includes presenting a list identifying the multiple discounts associated with one of the vendors to the user.

In yet other particular embodiments, the web page includes a link associated with one of the vendors. Also, presenting the list to the user includes presenting a pop-up window in response to a selection of the link by the user. The pop-up window includes the list identifying the multiple discounts.

In still other particular embodiments, the method further includes receiving a selection of one of the discounts in the list from the user. At least some of the pricing information is based on the selected discount.

In a second embodiment, an apparatus includes at least one memory configured to store information identifying an item. The apparatus also includes at least one processor configured to identify multiple vendors that offer the item and to identify multiple discounts associated with the item and/or the vendors. The at least one processor is also configured to provide pricing information associated with the item. At least some of the pricing information is based on at least one of the identified discounts.

In a third embodiment, a computer program is embodied on a computer readable medium. The computer program includes computer readable program code for identifying multiple vendors that offer an item. The computer program also includes computer readable program code for identifying multiple discounts associated with the item and/or the vendors. The computer program further includes computer readable program code for providing pricing information associated with the item. At least some of the pricing information is based on at least one of the identified discounts.

In a fourth embodiment, a method includes receiving pricing information associated with an item offered by multiple vendors. At least some of the pricing information is based on one or more discounts associated with the item and/or the vendors. The method also includes providing the pricing information to a user.

In a fifth embodiment, an apparatus includes at least one memory configured to store pricing information associated with an item offered by multiple vendors. At least some of the pricing information is based on one or more discounts associated with the item and/or the vendors. The apparatus also includes at least one processor configured to provide the pricing information to a user.

In a sixth embodiment, a computer program is embodied on a computer readable medium. The computer program includes computer readable program code for receiving pricing information associated with an item offered by multiple vendors. At least some of the pricing information is based on one or more discounts associated with the item and/or the vendors. The computer program also includes computer readable program code for providing the pricing information to a user.

In a seventh embodiment, a method includes receiving pricing information associated with an item offered by multiple vendors. The method also includes, for at least one of the vendors, displaying a list of discounts associated with the item and/or the vendor. The method further includes receiving, from a user, a selection of one of the displayed discounts. In addition, the method includes displaying, to the user, at least a portion of the pricing information. At least some of the displayed pricing information is based on the selected discount.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example system for discount integration into an on-line pricing engine according to this disclosure;

FIG. 2 illustrates an example web page supporting discount integration into an on-line pricing engine according to this disclosure;

FIG. 3 illustrates an example method for generating a web page supporting discount integration into an on-line pricing engine according to this disclosure; and

FIG. 4 illustrates an example method for using a web page supporting discount integration into an on-line pricing engine according to this disclosure.

### DETAILED DESCRIPTION

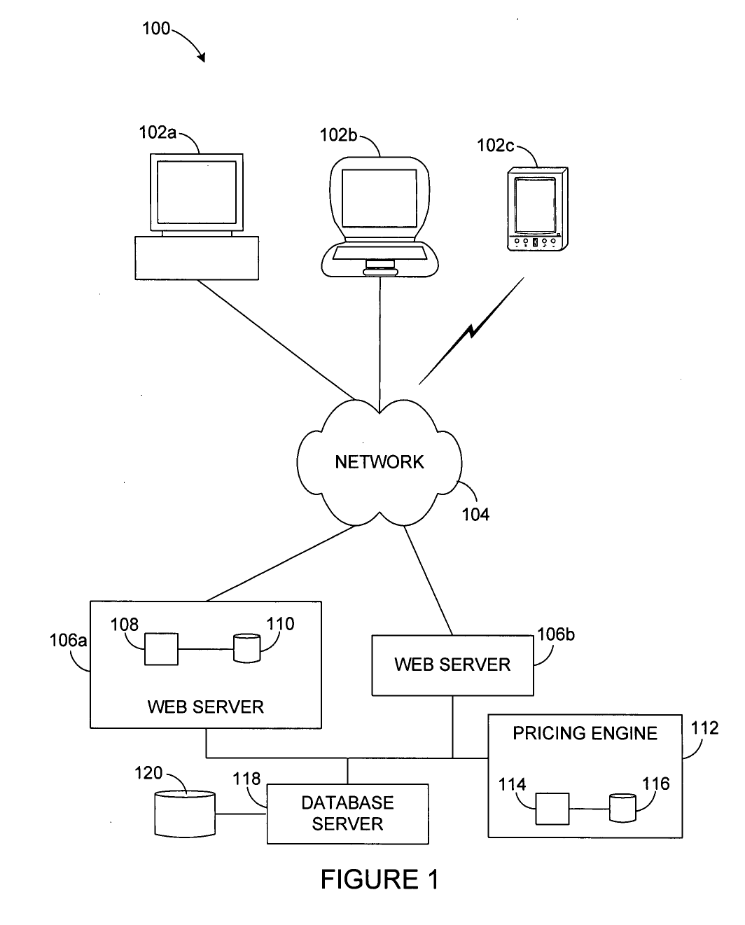

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for discount integration into an on-line pricing engine according to this disclosure. The embodiment of the system 100 shown in FIG. 1 is for illustration only. Other embodiments of the system 100 may be used without departing from the scope of this disclosure.

In this example embodiment, the system 100 includes various end user devices 102a-102c. Each of the user devices 102a-102c communicates over a network 104. For example, each of the user devices 102a-102c may receive and display web pages to a user, and the user could use the user device 102a-102c to provide information via the web pages (such as information identifying search criteria related to products or services). As described in more detail below, some of the web pages received by the user devices 102a-102c contain pricing information associated with products or services, and the pricing information includes or identifies coupons or other discounts related to the products or services. In this particular example, the user devices 102a-102c include a desktop computer (102a), a laptop computer (102b), and a personal digital assistant (102c). Each of these user devices 102a-102c communicates over a wired or wireless connection. These user devices 102a-102c are for illustration only. Any other or additional computing or communication devices may be used in the system 100. Each of the user devices 102a-102c includes any suitable structure allowing a user to communicate and interact over a network.

A network 104 facilitates communication between various components in the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

In this example, two web servers 106a-106b are coupled to the network 104. The web servers 106a-106b support communication and interaction with the user devices 102a-102c over the network 104. For example, the web servers 106a-106b may generate web pages and provide the web pages to the user devices 102a-102c over the network 104. As particular examples, the web servers 106a-106b may generate web pages that contain pricing information associated with one or more products or services. The pricing information could include the prices charged by various vendors offering a particular product or service. The pricing information could also include any coupons or other discounts associated with the products, services, or vendors. In this document, the term “offer” and its derivatives include any offer to sell, lease, rent, or otherwise provide a product or service. Also, the term “discount” and its derivatives refer to any reduction in the price or associated charges (such as shipping costs) related to a product or service, such as coupons for a product or service honored by a vendor. Further, the term “vendor” and its derivatives refer to any individual, business, or other entity offering a product or service. In addition, the term “item” and its derivatives are used in this patent document to denote both products and services.

In this particular example, two web servers 106a-106b are shown as being coupled to the network 104. In this embodiment, both web servers 106a-106b could be used to facilitate communications with the user devices 102a-102c. Also, any suitable technique could be used to route individual user devices 102a-102c to specific ones of the web servers 106a-106b, such as by using load-sharing techniques.

The web servers 106a-106b could use any suitable protocol(s) to communicate with the user devices 102a-102c. For example, the web servers 106a-106b could support the use of hypertext markup language (HTML) to communicate web pages to the user devices 102a-102c. The web servers 106a-106b could also support Secure Sockets Layer (SSL) or other techniques to facilitate secure communications with the user devices 102a-102c.

Each of the web servers 106a-106b includes any suitable structure for providing product or service pricing-related information to user devices. As a particular example, each of the web servers 106a-106b could include one or more processors 108 and one or more memories 110 containing instructions and data used, generated, or collected by the one or more processors 108.

In this example, a pricing engine 112 is coupled to or is otherwise accessible from the web servers 106a-106b. The pricing engine 112 contains logic, such as software routines, that can search for and identify pricing-related information for items offered by various vendors. The pricing engine 112 could, for example, receive information identifying a specific product from one of the web servers 106a-106b, search for any vendor that sells the specific product, and identify a price charged by each of the identified vendors. The pricing engine 112 could also identify additional information associated with a specific product or service or with vendors, such as shipping costs and taxes charged by the vendors and whether each of the vendors has a specific product in stock. The pricing engine 112 could make this information available to the web servers 106a-106b, which could include this information in web pages provided to the user devices 102a-102c.

As described in more detail below, the pricing engine 112 could also identify coupons or other discounts that are applicable to a particular product or service, such as discounts related to a particular product or a discount offered by a particular vendor. The pricing engine 112 could provide this information to the web servers 106a-106b for inclusion in the web pages provided to the user devices 102a-102c. The pricing engine 112 could also use this information to identify the largest discount available from each vendor for a particular product or service and to identify the lowest discounted price for the particular product or service.

The pricing engine 112 includes any suitable structure for identifying prices (and possibly related charges) for products or services and incorporating coupons or other discounts. As a particular example, the pricing engine 112 could include one or more processors 114 and one or more memories 116 containing instructions and data used, generated, or collected by the one or more processors 114.

A database server 118 is coupled to the web servers 106a-106b, the pricing engine 112, and a database 120. The database 120 stores various information used, collected, or generated by the web servers 106a-106b and the pricing engine 112. For example, the database 120 could store information identifying prices for various products or services offered by on-line vendors. The database 120 could also store information identifying shipping costs, tax rates, addresses, payment information, and other information associated with the vendors. The database 120 could further store information identifying coupons or other discounts for products or services, such as discounts that are associated with particular items, particular types of items, or particular vendors. The pricing engine 112 could access and use this information to identify vendors that offer a specified product or service, the prices charged by the vendors, and any discounts applicable to the product, service, or vendor.

The database server 118 provides access to and control over the data stored in the database 120. For example, the database server 118 can support the storage of data in and the retrieval of data from the database 120. The database server 118 may also ensure that components attempting to access the database 120 are authorized.

The database server 118 includes any suitable structure for providing access to a database of information. The database 120 includes any suitable structure for storing and facilitating retrieval of information. The database 120 also uses any of a variety of data structures, arrangements, and compilations to store and facilitate retrieval of information.

In one aspect of operation, the web servers 106a-106b receive requests for pricing information related to products or services from the user devices 102a-102c. Example requests could identify a specific item or include search criteria for identifying one or more items. The pricing engine 112 identifies any vendors offering the identified item(s), identifies prices and related charges associated with the item(s), and identifies any applicable coupons or other discounts. This information is made available to the web servers 106a-106b, which generate web pages containing the information. In particular, the web pages can identify one or more of the discounts available for each of the identified vendors. The users of the user devices 102a-102c can, among other things, examine the identified discounts, select different discounts, and view how the various discounts affect the total price of an item. Additional information regarding the web pages generated by the web servers 106a-106b and the operations performed by the pricing engine 112 are provided below.

This represents one example of how the system 100 may operate. The system 100 may operate in any other suitable manner. For example, the web servers 106a-106b could receive a request to identify all products or services offered by a particular vendor. As another example, the pricing engine 112 could allow a user to enter a coupon code or other discount code, determine if the code is valid, and display how the user's discount affects the total price of an item. The system 100 may operate in various other ways depending on the particular implementation of the web servers 106a-106b, the pricing engine 112, or other components in the system 100.

Although FIG. 1 illustrates one example of a system 100 for discount integration into an on-line pricing engine, various changes may be made to FIG. 1. For example, the system 100 may include any number of user devices, networks, web servers, pricing engines, database servers, and databases. Also, the functional division shown in FIG. 1 is for illustration only. Various components in FIG. 1 could be combined or omitted and additional components could be added according to particular needs. Further, the layout of the components shown in FIG. 1 is for illustration only. The components of the system 100 could be arranged in any other suitable manner, such as when the pricing engine 112 is coupled to the network 104 and is accessed by the web servers 106a-106b over the network 104. In addition, while FIG. 1 illustrates one operational environment in which discount integration into an on-line pricing engine can be used, this functionality could be used in any other suitable system.

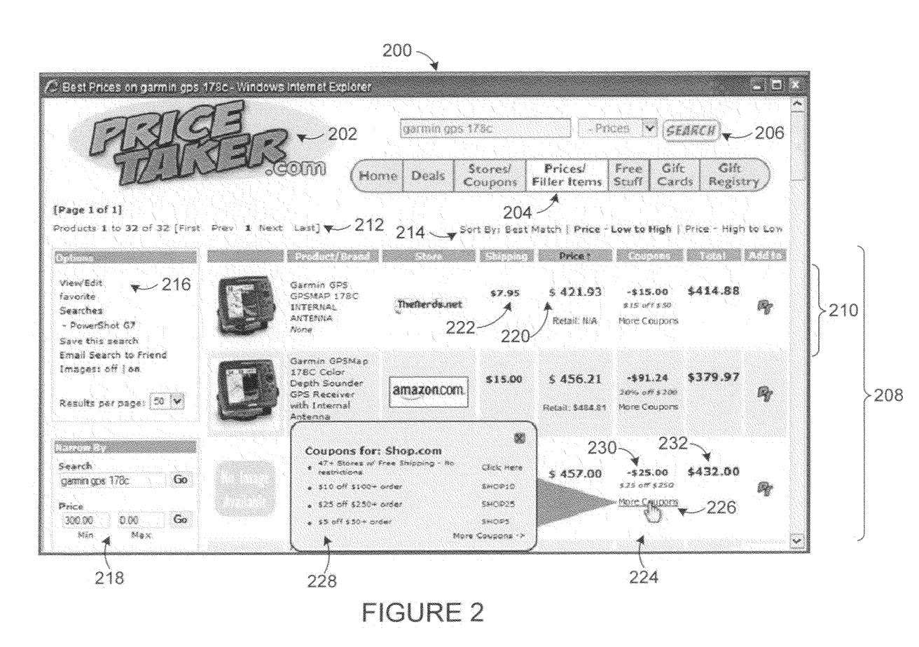

FIG. 2 illustrates an example web page 200 supporting discount integration into an on-line pricing engine according to this disclosure. The embodiment of the web page 200 shown in FIG. 2 is for illustration only. Other embodiments of the web page 200 could be used without departing from the scope of this disclosure.

As shown in FIG. 2, the web page 200 includes various information and controls at the top of the web page 200. For example, the web page 200 includes a logo 202 identifying the entity that owns or operates the website being accessed or that identifies the name of the website itself. The web page 200 also includes various tabs 204, which can be used to access different types of information. In this example, a “Prices/Filler Items” tab 204 has been selected, which indicates that the user is requesting or has requested pricing information.

The web page 200 also supports a text search 206, which allows a user to search for prices and other charges related to one or more products or services. As an example, the user could enter text (such as a product name or product type), specify what type of search is desired (such as “prices”), and initiate the search.

In this example, pricing information associated with one or more products or services is provided in a table 208. The table 208 in this example embodiment includes various rows 210, each of which presents information associated with a single item provided by a single vendor. For example, each row 210 can identify the name of a product and the name of a vendor that offers the product. The web page 200 also includes navigation links 212 that can be used by a user to navigate through the table 208. For instance, the table 208 can be divided into multiple pages (where only one page is displayed at any given time in the web page 200), and the navigation links 212 can be used to select the first, previous, next, or last page of the table 210. The web page 200 further includes sorting links 214, which can be used to sort the displayed items in various ways (such as low-to-high price, high-to-low price, or best match-to-worst match for search criteria). The user could click on various column headers of the table 208 (such as “Shipping,” “Price,” “Coupons,” or “Total”) to select the values that are sorted. In this example, an arrow next to the “Price” column label indicates that the base prices of the items are sorted in ascending order.

In this example, the web page 200 also includes various options 216 that can be selected or set by the user. These options include the ability to save particular search results, view prior search results, send search results to someone else, control whether images are displayed in the table 208, and control the number of rows 210 displayed on the web page 200. The web page 200 further includes controls 218 for narrowing the current search results, such as by searching for keywords within the current search results or limiting the current search results to certain prices. Although not shown, other techniques could be used to narrow the current search results, such as by presenting the user with a list of product brands or vendors and allowing the user to select one (thereby limiting the current search results to the selected product brand or vendor).

As shown in FIG. 2, each row 210 of the table 208 may include a price 220 associated with an item and, if the information is available, a shipping cost 222 for obtaining the specified item from a vendor. The table 210 also includes a coupon or discount column 224, which identifies any coupons or other discounts associated with the displayed item(s) and vendor(s).

In this example embodiment, if any discounts are available and can be used for a particular item from a particular vendor, a coupon link 226 is presented in the appropriate row 210. The coupon link 226 can be selected by the user to open a pop-up window 228, which identifies one or multiple discounts available for selection by the user. The pop-up window 228 in this example includes multiple discounts and a link that can be selected to view additional discounts.

The user can select one of the coupons or other discounts presented in the pop-up window 228. The selected discount can be displayed as a discount 230 in the appropriate row 210 of the table 208, or an actual dollar value can be calculated and displayed as the discount 230 in the appropriate row 210. The discount 230 in each row 210 can also be used to calculate a total cost 232 for obtaining the product or service from the particular vendor associated with that row 210.

In some embodiments, the pricing engine 112, when collecting the pricing information to satisfy a user's request, can identify the coupon or other discount that results in the lowest total cost 232 (or highest discount 230) for each row 210 of the table 208. These “best” or “optimal” discounts can be used by the web servers 206a-206b so that the web page 200 is initially displayed to the user already identifying the “best” discounts identified by the pricing engine 112. As another example, the pricing engine 112 could identify the discount for each row 210 that most users qualify for (such as a discount offered to regular users of a software program). The user can then use the coupon link 226 and examine the pop-up window 228 to determine if the user qualifies for an even better discount (such as a student discount for the software). In other embodiments, the pricing engine 112 could present a coupon link 226 in each row 210 of the table 208 and wait for the user to select a particular discount before calculating the discount 230 (and possibly the total cost 232) for that row 210. In still other embodiments, the pricing engine 112 could identify the “best” discount for each row 210 of the table 208, and the user may not view or select other discounts (such as when the coupon links 226 are omitted from the web page 200).

In this way, the pricing engine 112 can identify various prices for a particular product or service from one or multiple vendors, while taking into account coupons or other discounts available to the user. Also, the user could be able to review the available discounts and select a particular discount. As a result, the user may be able to obtain a product or service at the lowest possible cost.

Although FIG. 2 illustrates one example of a web page 200 supporting discount integration into an on-line pricing engine, various changes may be made to FIG. 2. For example, the web page 200 could include any other or additional information, and the web page 200 could have any suitable arrangement and layout. Also, the contents of the table 208 are for illustration only. The table 208 could include any other or additional information in any suitable arrangement and layout.

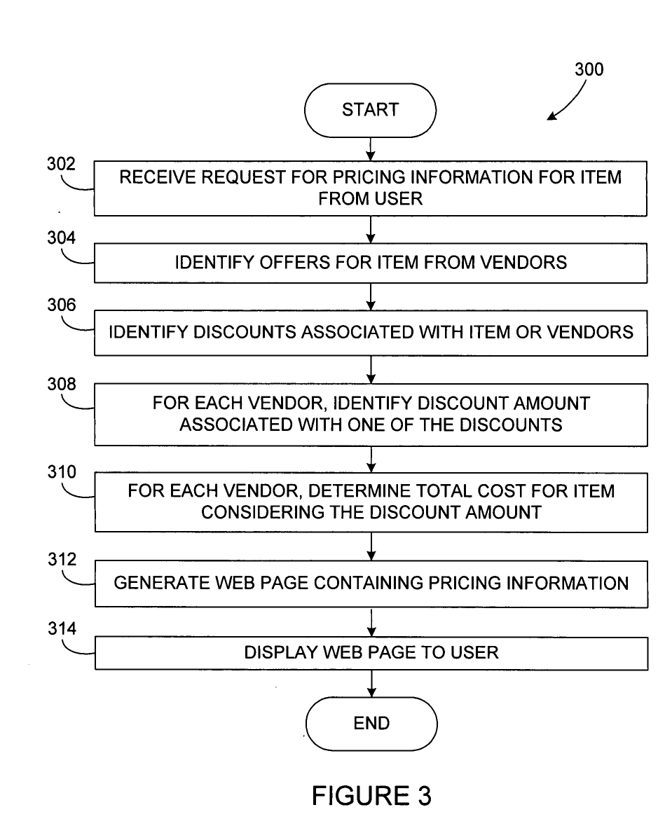

FIG. 3 illustrates an example method 300 for generating a web page supporting discount integration into an on-line pricing engine according to this disclosure. The embodiment of the method 300 shown in FIG. 3 is for illustration only. Other embodiments of the method 300 could be used without departing from the scope of this disclosure. Also, for ease of explanation, the method 300 is described with respect to the web page 200 of FIG. 2 being used in the system 100 of FIG. 1. The method 300 could be used with any suitable web page generated or used in any suitable system.

A request for pricing information for an item is received from a user at step 302. This could include a web server 106a-106b receiving a request for product or service pricing information from a user over the network 104. As a particular example, the user may access a web page provided by the web server 106a-106b, and the user could request pricing information by providing search criteria using the web page.

One or more offers related to the item are identified at step 304. This could include the pricing engine 112 identifying one or more vendors that offer the identified product or service. This could also include the pricing engine 112 identifying a price charged by each of the vendors for the identified product or service.

One or more coupons or other discounts are identified at step 306. This could include the pricing engine 112 identifying at least one coupon or other discount related to the identified product or service. This could also include the pricing engine 112 identifying at least one coupon or other discount related to each of the identified vendors.

For each of the identified vendors, a discount amount for one of the discounts is identified at step 308. This could include the pricing engine 112, for each vendor, identifying the coupon or other discount that provides the user with the largest savings. This could also include the pricing engine 112 identifying the actual value of the savings if that particular coupon or other discount is used by the user.

For each of the identified vendors, a total cost of the identified item is determined at step 310. This could include the pricing engine 112, for each vendor, determining a total cost of the identified product or service. The total cost can take into consideration the actual price of the product or service, the largest discount amount, any shipping costs or taxes, and any other suitable values.

A web page containing the pricing information is generated at step 312. This could include, for example, the web server 106a-106b generating a web page 200 that contains a table 208 with rows 210 for the identified vendors that provide the item. Each of the rows 210 could identify the name of a vendor, the name of a product or service, the price of the product or service, the largest discount amount identified, and the total cost of the product or service. Each row 210 in the web page 200 could also include a coupon link 226 allowing the user to view the discounts associated with a product, service, or vendor.

The web page is displayed to the user at step 314. This could include, for example, the web server 106a-106b communicating the web page 200 using HTML to a user device 102a-102c used by the user. This may also include the user device 102a-102c presenting the generated web page 200 to the user.

Although FIG. 3 illustrates one example of a method 300 for generating a web page supporting discount integration into an on-line pricing engine, various changes may be made to FIG. 3. For example, while the method 300 is shown as identifying vendors, prices, discounts, and total costs for a single item, the same or similar technique could be used for multiple items. As a particular example, the same or similar technique could be used for multiple products or services that match a user's search criteria.

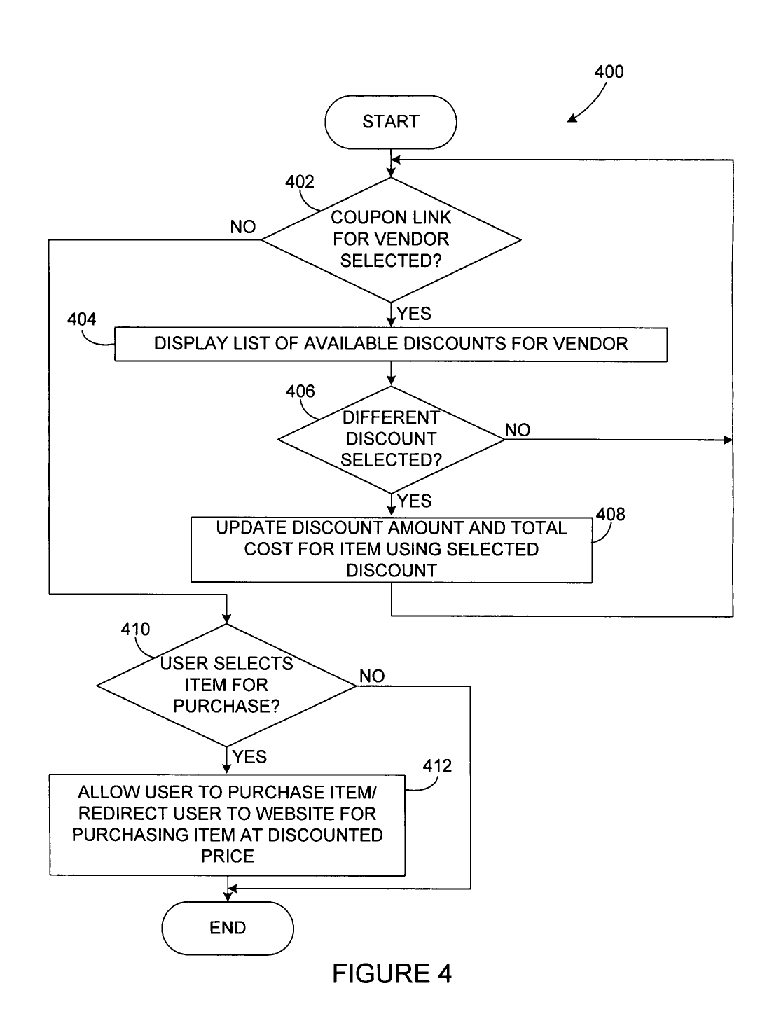

FIG. 4 illustrates an example method 400 for using a web page supporting discount integration into an on-line pricing engine according to this disclosure. The embodiment of the method 400 shown in FIG. 4 is for illustration only. Other embodiments of the method 400 could be used without departing from the scope of this disclosure. Also, for ease of explanation, the method 400 is described with respect to the web page 200 of FIG. 2 being used in the system 100 of FIG. 1. The method 400 could be used with any suitable web page generated or used in any suitable system.

After the web page 200 has been displayed to a user, a determination is made whether a coupon link for a vendor is selected at step 402. This could include the web server 106a-106b identifying when the user has used a mouse to click on the coupon link 226 in one of the rows 210 in the web page 200.

If a coupon link is selected, a list of available discounts is displayed to the user at step 404. This could include the web server 106a-106b displaying a pop-up window 228 containing multiple discounts associated with a particular product, service, or vendor. The pop-up window 228 could also include a link for viewing additional discounts that can be selected by the user.

A determination is made whether a different discount is selected at step 406. This could include the web server 106a-106b identifying when the user selects a different coupon or other discount in the pop-up window 228. If a different discount is not selected, the method 400 returns to step 402 to allow the user to select another coupon link. Otherwise, the discount amount and total cost of the item associated with the selected discount is updated at step 408. This could include the pricing engine 112 determining the discount amount associated with the selected discount and then using the discount amount to calculate the total cost of the product or service. The method 400 then returns to step 402 to allow the user to again select a coupon link.

If no coupon link is selected at step 402, a determination is made whether the user has selected an item for purchase at step 410. If not, the method 400 ends. Otherwise, the user has selected an item for purchase, and the user is allowed to purchase the item or is redirected to a website for purchasing the item at the discounted price at step 412. This could include the web server 106a-106b adding the selected product or service to the user's shopping cart, where the price of the selected product or service is based on the selected coupon or other discount. This could also include the web server 106a-106b redirecting the user (such as by redirecting the user's current web browser window or opening a new web browser window) to the identified vendor's website, where the user could purchase the selected product or service.

Although FIG. 4 illustrates one example of a method 400 for using a web page supporting discount integration into an on-line pricing engine, various changes may be made to FIG. 4. For example, while the method 400 is shown as involving the selection of discounts and the determination of total costs for a single item, the same or similar technique could be used for multiple items. As a particular example, the same or similar technique could be used for multiple products or services that match a user's search criteria.

In some embodiments, various functions described above can be implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
identifying multiple vendors that offer an item;
identifying multiple discounts associated with at least one of: the item and the vendors; and
providing a web page comprising pricing information associated with the item to a user, at least some of the pricing information based on at least one of the discounts.

2. The method of claim 1, wherein multiple discounts are associated with each of one or more of the vendors; and
further comprising identifying an optimal discount for at least one of the vendors, wherein at least some of the pricing information is based on the optimal discount.

3. The method of claim 1, wherein multiple discounts are associated with each of one or more of the vendors; and
further comprising presenting a list identifying the multiple discounts associated with one of the vendors to the user.

4. The method of claim 3, wherein:
the web page comprises a link associated with one of the vendors; and
presenting the list to the user comprises presenting a pop-up window in response to a selection of the link by the user, the pop-up window comprising the list identifying the multiple discounts.

5. The method of claim 3, further comprising:
receiving a selection of one of the discounts in the list from the user, wherein at least some of the pricing information is based on the selected discount.

6. The method of claim 1, wherein the web page comprises, for each vendor:
a price of the item offered by the vendor;
a discount amount associated with one of the discounts; and
a total cost of the item offered by the vendor, the total cost based on the discount amount.

7. The method of claim 1, further comprising:
receiving search criteria from the user; and
identifying multiple items satisfying the search criteria;
wherein the pricing information is associated with the multiple items.

8. The method of claim 7, wherein the web page comprises multiple links, each link associated with one of the vendors; and
further comprising displaying multiple ones of the discounts in response to a selection of one of the links by the user.

9. The method of claim 1, wherein:
the item comprises a product offered for sale by the vendors; and
the discounts comprise coupons honored by the vendors.

10. The method of claim 1, wherein:
a pricing engine identifies the vendors and the discounts; and
a web server generates the web page using the pricing information from the pricing engine.

11. An apparatus comprising:
at least one memory configured to store information identifying an item; and
at least one processor configured to:
identify multiple vendors that offer the item;
identify multiple discounts associated with at least one of: the item and the vendors; and
provide pricing information associated with the item, at least some of the pricing information based on at least one of the identified discounts.

12. The apparatus of claim 11, wherein:
multiple discounts are associated with each of one or more of the vendors; and
the at least one processor is further configured to identify an optimal discount for at least one of the vendors, wherein at least some of the pricing information is based on the optimal discount.

13. The apparatus of claim 11, wherein the at least one processor is further configured to:
receive search criteria from a user; and
identify multiple items satisfying the search criteria;
wherein the pricing information is associated with the multiple items.

14. The apparatus of claim 11, wherein:
the item comprises a product offered for sale by the vendors; and
the discounts comprise coupons honored by the vendors.

15. The apparatus of claim 11, wherein the at least one processor is configured to provide the pricing information to a web server, the web server configured to generate a web page comprising the pricing information.

16. A computer program embodied on a computer readable medium, the computer program comprising computer readable program code for:
identifying multiple vendors that offer an item;
identifying multiple discounts associated with at least one of: the item and the vendors; and
providing pricing information associated with the item, at least some of the pricing information based on at least one of the identified discounts.

17. The computer program of claim 16, wherein multiple discounts are associated with each of one or more of the vendors; and
further comprising computer readable program code for identifying an optimal discount for at least one of the vendors, wherein at least some of the pricing information is based on the optimal discount.

18. The computer program of claim 16, further comprising computer readable program code for:
receiving search criteria from a user; and
identifying multiple items satisfying the search criteria;
wherein the pricing information is associated with the multiple items.

19. The computer program of claim 16, wherein:
the item comprises a product offered for sale by the vendors; and
the discounts comprise coupons honored by the vendors.

20. A method comprising:
receiving pricing information associated with an item offered by multiple vendors, at least some of the pricing information based on one or more discounts associated with at least one of: the item and the vendors; and
providing the pricing information to a user.

21. The method of claim 20, wherein:
multiple discounts are associated with each of one or more of the vendors; and
further comprising presenting a list identifying the multiple discounts associated with one of the vendors to the user.

22. The method of claim 21, wherein:
providing the pricing information comprises generating a web page, the web page comprising the pricing information and a link associated with one of the vendors; and
presenting the list comprises presenting a pop-up window in response to a selection of the link by the user, the pop-up window comprising the list identifying the multiple discounts.

23. The method of claim 21, further comprising:
receiving a selection of one of the discounts in the list from the user, wherein at least some of the pricing information is based on the selected discount.

24. The method of claim 20, wherein providing the pricing information comprises generating a web page, the web page comprising, for each vendor:
a price of the item offered by the vendor;
a discount amount associated with one of the discounts; and
a total cost of the item offered by the vendor, the total cost based on the discount amount.

25. The method of claim 20, wherein:
the item comprises one or more products offered for sale by the vendors;
the discounts comprise coupons honored by the vendors; and
the pricing information is associated with the one or more products.

26. An apparatus comprising:
at least one memory configured to store pricing information associated with an item offered by multiple vendors, at least some of the pricing information based on one or more discounts associated with at least one of: the item and the vendors; and
at least one processor configured to provide the pricing information to a user.

27. The apparatus of claim 26, wherein:
multiple discounts are associated with each of one or more of the vendors; and
the at least one processor is further configured to present a list identifying the multiple discounts associated with one of the vendors to the user.

28. The apparatus of claim 27, wherein:
the at least one processor is configured to provide the pricing information by generating a web page, the web page comprising the pricing information and a link associated with one of the vendors; and
the at least one processor is configured to present the list by presenting a pop-up window in response to a selection of the link by the user, the pop-up window comprising the list identifying the multiple discounts.

29. The apparatus of claim 27, wherein:
the at least one processor is further configured to receive a selection of one of the discounts in the list from the user; and
the at least one processor is configured to provide the pricing information based on the selected discount.

30. The apparatus of claim 26, wherein the at least one processor is configured to present the pricing information by generating a web page, the web page comprising, for each vendor:
a price of the item offered by the vendor;
a discount amount associated with one of the discounts; and
a total cost of the item offered by the vendor, the total cost based on the discount amount.

31. The apparatus of claim 26, wherein:
the item comprises one or more products offered for sale by the vendors;
the discounts comprise coupons honored by the vendors; and
the pricing information is associated with the one or more products.

32. A computer program embodied on a computer readable medium, the computer program comprising computer readable program code for:
receiving pricing information associated with an item offered by multiple vendors, at least some of the pricing information based on one or more discounts associated with at least one of: the item and the vendors; and
providing the pricing information to a user.

33. The computer program of claim 32, wherein:
multiple discounts are associated with each of one or more of the vendors; and
further comprising computer readable program code for presenting a list identifying the multiple discounts associated with one of the vendors to the user.

34. The computer program of claim 33, wherein:
the computer readable program code for providing the pricing information comprises computer readable program code for generating a web page, the web page comprising the pricing information and a link associated with one of the vendors; and
the computer readable program code for presenting the list comprises computer readable program code for presenting a pop-up window in response to a selection of the link by the user, the pop-up window comprising the list identifying the multiple discounts.

35. The computer program of claim 33, further comprising computer readable program code for receiving a selection of one of the discounts in the list from the user, wherein at least some of the pricing information is based on the selected discount.

36. The computer program of claim 32, wherein the computer readable program code for providing the pricing information comprises computer readable program code for generating a web page, the web page comprising, for each vendor:
a price of the item offered by the vendor;
a discount amount associated with one of the discounts; and
a total cost of the item offered by the vendor, the total cost based on the discount amount.

37. The computer program of claim 32, wherein:
the item comprises one or more products offered for sale by the vendors;
the discounts comprise coupons honored by the vendors; and
the pricing information is associated with the one or more products.

38. A method comprising:
receiving pricing information associated with an item offered by multiple vendors;
for at least one of the vendors, displaying a list of discounts associated with at least one of: the item and the vendor;
receiving, from a user, a selection of one of the displayed discounts; and
displaying, to the user, at least a portion of the pricing information, at least some of the displayed pricing information based on the selected discount.
